(19) United States
(12) Patent Application Publication
(10) Pub. No.: US 2008/0025514 A1
(43) Pub. Date: Jan. 31, 2008

(54) Systems And Methods For Root Certificate Update

(76) Inventor: Jason Scott Coombs, Kohala, HI (US)

Correspondence Address: MCANDREWS HELD & MALLOY, LTD, 500 WEST MADISON STREET, SUITE 3400, CHICAGO, IL, 60661, US

(21) Appl. No.: 11/828,187

(22) Filed: Jul. 25, 2007

Related U.S. Application Data
(60) Provisional application No. 60/833,237, filed on Jul. 25, 2006.

(51) Int. Cl. H04L 9/16; H04L 9/30

(52) U.S. Cl. 380/277; 380/30

(57) ABSTRACT

Certain embodiments of the present invention provide a method for replacing a cryptographic key including receiving a key replacement message for replacing the cryptographic key, decrypting at least part of the key replacement message using at least part of the cryptographic key, reading from the key replacement message at least part of at least a first replacement cryptographic key or at least a first replacement cryptographic key precursor value that is used to derive a first replacement cryptographic key, and replacing the cryptographic key with at least part of the first replacement cryptographic key. The key replacement message includes encrypted data. The encrypted data having been encrypted using at least part of at least a third cryptographic key. Decrypting the encrypted data using at least part of the cryptographic key. The decrypting being associated with verifying a digital signature.

### RELATED APPLICATIONS

This application is related to, and claims the benefit of, Provisional Application No. 60/833,237, filed on Jul. 25, 2006, and entitled “A System or Method of Creating Cryptographic Command or Control Channels with Layers of Digital Signature Authentication or Verification of Digital Communications Enabling Remote Control Over, or Distribution of Arbitrary Reprogramming or Reconfiguration Instructions to, One or More General Purpose Programmable Electronic Devices.” The foregoing application is herein incorporated by reference in its entirety.

### FEDERALLY SPONSORED RESEARCH OR DEVELOPMENT

Not Applicable

### MICROFICHE/COPYRIGHT REFERENCE

Not Applicable

### BACKGROUND OF THE INVENTION

The present invention generally relates to updating a cryptographic key by replacing an existing cryptographic key with a replacement cryptographic key.

A mechanism to realize digital signatures using an asymmetric cryptographic key pair, generally termed a public key and a private key, is a common feature of various electronic systems and prior art in the field of cryptology. The definition of digital signature is sometimes imprecise, as cryptographers tend to have one idea of the meaning of this term while engineers have another idea. To further complicate the search for a precise definition, the information security field routinely points out that definitions used by both cryptographers and engineers are foolish or simply wrong because prior art devices and methods that exist in the real world to create, transmit, and verify digital signatures are vulnerable in subtle ways that spoil cryptographers' and engineers' idealistic viewpoints on the subject.

However, using a precise definition of digital signature helps curtail the tendency to forget what they truly are when we imagine what they might be able to help us do to make digital technology safer or more reliable. The most precise definition of digital signature, common to all three of the fields of cryptology, engineering, and information security, is a cryptographic transformation involving at least one key, or employing at least one secret algorithm as a substitute for a key, in order to transform a message such that the result of the transformation can be compared against an expected result during a signature verification process to determine whether it is probable that the message was, at some time in the past, under the control of an entity that was capable of transforming the message such that the expected result of said comparison would be obtained by an entity that attempts to verify the digital signature in the future. Such entities can be people or devices that are capable of following detailed instructions to process data for example. Most digital signature schemes only ensure a degree of probability, they don't conclusively prove that a particular message was transformed using a particular key.

Typically, digital signatures are easy to compute and easy to verify because they involve two keys (or algorithms) comprised of mathematically-related numerical values (or formulae) that enable the holder of a second key to compute a digital signature verification result from the output of a prior cryptographic transformation. The holder of the second key performs such computation by transforming the digital signature, which itself is merely the output of a prior transformation of a message. The result that is expected when a digital signature is transformed is easy for the holder of a first key to ensure that the holder of the second key can obtain, computationally, if the digital signature in fact corresponds to the original message, assuming the holder of the second key has a true and correct copy of the original message, and where the second key is the correct key (or algorithm) related mathematically to the first key (or algorithm). We say that digital signatures are easy for parties who hold the appropriate keys to create and verify, even though the algorithms are often complex, because it is considered very hard for an adversary to discover the keys by analyzing the output of cryptographic transformations that utilize the keys, and because it is extremely hard for a party who lacks the keys to ever create or verify digital signatures. It's easy with the keys but very hard without them.

8 In some systems, algorithms may be used as keys. That is, rather than using a numerical value as a key, an algorithm is used instead. An algorithm can have a related algorithm just as keys used to create and verify digital signatures can be related. When algorithms are used as keys, at least one of the algorithms is typically kept secret in order for the digital signature system to function effectively. Thus, as used herein, a key may refer to a value or an algorithm, as described above. That is, the term key is used to mean either or both.

It is commonly believed that only a holder of the first key is able to perform the cryptographic transformation needed in order to produce a digital signature such that a holder of the second key could then compute the expected result from the digital signature when attempting to verify the digital signature using the second key and a copy of the original message. This quality of such a system, binding a message and a first key in such a way that only a second key can verify that the first key and the message were so bound, is part of what gives a digital signature its utility as the digital signature is a simple mathematical proof to demonstrate probability of such binding. Keeping it simple to verify a digital signature is a typical design goal of digital signatures, while ensuring that it remains extremely difficult to discover the first key given only the second key, the digital signature, and the original message, is another typical design goal. A scheme that achieves both goals simultaneously gives meaning, purpose, and value to digital signatures.

Typical digital signature methods use asymmetric encryption, meaning that a second key, a public key, is able to decrypt a cryptographic transformation produced using a first key, a private key. This is distinct from symmetric encryption in which the same secret key is used for both encryption and decryption.

To compute a digital signature, a holder of the first key encrypts some data, typically a hash code value that is computed by using a one-way function that digests a message to be signed into a numeric value of a data length usually shorter than that of the message being signed. By encrypting a small amount of data that results from a one-way hash function involving the message being signed, instead of encrypting the entire message, the creators of such digital signature schemes believe the scheme is made more efficient because the signature does not take up as much data storage space as the original message. This reasoning makes some sense for slow or limited-capacity systems, but is similar to faulty reasoning that resulted in the Y2K bug.

In many current systems, however, the use of one-way hash functions makes it possible to forge digital signatures in a variety of ways that would not be possible if the entire message were simply encrypted using the first key. Encrypting the entire message with the digital signature private key would provide greater resistance to forged digital signatures, but most engineers are satisfied today with merely periodically improving the one-way function hash algorithms that are used in digital signature systems rather than burdening those systems with the best-possible, most secure features in the first place. Additionally, the use of asymmetric encryption for the purpose of privacy and cryptographic access control over sensitive information has become a routine practice in nearly every industry due to widespread use of computers and the Internet.

Current systems suffer from a common security flaw resulting from the practical risk of private key theft and problems associated with the process of issuing replacement keys to end-users when a private key is compromised. In addition to the risk of theft, a private key can be discovered by a third-party, computationally, through cryptanalytical methods. Popular belief is that such cryptanalytical discovery is improbable as a result of the cryptographic key strength of the asymmetric cryptosystems involved in digital signatures or asymmetric encryption. However, new methods are constantly emerging that make it increasingly likely that private keys can be discovered through cryptanalysis alone, without requiring an adversary to intercept all or part of any secret, or to find a way to steal the private key itself.

Private keys can also be lost or become inaccessible due to loss of another key required for decryption of a stored private key. Equipment failures, natural disasters, acts of war or sabotage, and all manner of other practical physical threats to information security can equally deprive the owner of an asymmetric key pair of the ability to use a particular trusted private key to compute new digital signatures, or remove the ability to decrypt information that has been encrypted using the corresponding public key.

Partial solutions for problems of key loss or theft have been developed, including key revocation, key escrow schemes, and trusted key recovery agents, to avoid the consequences of data loss or to revoke or cancel trust in compromised keys. Redundant storage of multiply-keyed ciphertext data eliminates a single point of failure that loss of a decryption key otherwise represents, but existing solutions for mitigating risk of data loss do not also solve the more serious security problems that are created when certain trusted public/private key pairs used in digital signature systems, such as so-called root keys, are lost or stolen and need to be replaced.

Revocation lists and expiration dates have served to minimize the window of exposure to the risk of stolen or cryptanalytically-compromised keys, particularly in systems that employ trust chains with a plurality of key pairs, digital certificates with such revocation lists, and certificate expiration events that are common or there is inherently a degree of distributed, automated trust.

Revoking or expiring a trusted key merely suspends the automatic trust previously extended to that key. Vulnerable systems typically provide the ability to continue to use an untrusted key even though that key has expired or been revoked. A key owner may unwittingly facilitate further security breaches within systems that require trusted key replacement if the key owner fails to recognize the fact that a stolen private key enables an attacker to forge a digital signature that appears valid, either automatically inside any system that still trusts the stolen key, or by practical implication by virtue of flawed human decisions during end-users' efforts to install a replacement key at the request of a malicious third-party who impersonates the true key holder.

End-users presently have no way to differentiate between a forged signature and a legitimate one, and so are inclined to give a digital signature the benefit of the doubt when the signature appears to verify as cryptographically-valid, even in the case where the private key used to create the digital signature has been designated expired or has been revoked. By routinely notifying end-users that it is necessary for them to install a replacement key or digital certificate as part of security incident response undertaken by the key owner following loss or theft of a trusted key, the trusted key owner makes it easy for a malicious third-party attacker to trick end-users into installing a substitute replacement key instead using simple identity theft or impersonation tricks.

Furthermore, serious forensic difficulties can emerge, such as being unable to distinguish tampering from authentic changes made to data, while investigating circumstances where data tampering may have occurred as a result of an attacker's ability to forge digital signatures, substitute malicious replacement keys, or deposit malicious ciphertext into a data storage whose integrity depends primarily on secrecy of a key that has been compromised. It is therefore crucial that an improved facility for secure key replacement be deployed as part of any cryptographic system that may require trusted key updates in the future.

Some current systems, such as U.S. Pat. Nos. 5,761,306 and 6,240,187, issued to Lewis, for example, discuss a system for communicating a replacement public key by way of a key replacement message that includes two digital signatures. One digital signature is verifiable by the public key that is being replaced in the system, and one digital signature is verifiable by either the private key that corresponds to the replacement public key or by the replacement public key itself (as would more logically be expected, as a private key is not normally used to verify a digital signature but instead is used to create one). In practice, the system discussed by Lewis results in digital signatures that either cannot be created at all, in the case where the private key that corresponds to the public key that is being replaced has been lost or destroyed due to a disaster or other event, or digital signatures that cannot be verified by any recipient that lacks knowledge of the replacement private key due to illogical requirements of a Lewis system.

Furthermore, Lewis teaches that the private key must also be sent in key replacement messages, which is illogical because sending the private key to any other party, even one that is participating in the cryptographic system, defeats the purpose of the digital signature scheme by disclosing the key that normally is kept secret in order for digital signatures to have their intended meaning. Disclosing a private key is also illogical because eavesdroppers or intruders will potentially intercept the key.

Of particular concern is a defect in the design of the Lewis invention that results from failing to address an information security threat to which the Lewis invention is vulnerable. The threat can be described generally as a member of a chosen ciphertext and key substitution attack. An adversary who knows the value of the active private key (Apr) is capable of forcing the Lewis system to utilize a decryption key chosen by the attacker such that when the ciphertext of the replacement public key is decrypted using the attacker's substituted decryption key, the result is replacement of the active public key (Apu) with a public key that is known only to the adversary.

The nature of this information security vulnerability is such that it is a relatively common byproduct of poorly-understood cryptography implemented by software engineers. A hidden flaw in the Lewis design will become apparent by considering that a cryptographic transformation such as a decryption step is merely a mathematical computation. Those of skill in the art of information security are aware that software engineers frequently attribute, in their minds, a quality of ‘correctness’ or ‘wrongness’ to a mathematical operation because that is how these engineers think of such things when they write software program source code. In fact there is no quality of ‘right’ or ‘wrong’ in mathematics, there are only computational results, ‘accurately computed’ or ‘inaccurately computed’. Put another way, unless a computer malfunctions, electromechanically, or is tampered with on purpose, it is impossible for a computer to be ‘wrong’ in its computational results, a computer merely carries out its programming instructions deterministically and reproducibly. Accurate computations may still result in a meaningless result, as in the case where a logical error is introduced by a programmer, but incorrect results that come from programming mistakes cannot be blamed on mathematics, those mistakes are human error. Additional steps are required in order to evaluate the contextual meaning and quality of computational results to determine if they are ‘expected’ or ‘unexpected’ within known limits and human expectations.

An engineer who follows the proscribed steps of the Lewis invention will arrive at an endpoint where a serious vulnerability lies hidden, waiting to be exploited by an attacker. For example, here is what happens when cryptographic masking taught by Lewis is implemented in practice.

A. A next replacement public key (termed R1pu in a Lewis system) is masked using cryptographic technique (e.g. either a hash algorithm or an encrypting transformation using a secret encryption key).

B. The mask of R1pu (termed H(R1pu) or E_X1(R1pu) in a Lewis system) is extracted from message 42 and stored in storage 20 of the Lewis system.

C. In the case of masking with a hash algorithm, when a key replacement message is received by a user node either the replacement private key (Rpr) or the replacement public key (Rpu) is supplied as taught variously by embodiments of Lewis (FIG. 4 showing details of message 42 requires the replacement private key to be supplied within the key replacement message which is illogical but that is what Lewis teaches nevertheless) and when Rpu is supplied there is no clear requirement in Lewis that the value of Rpu be compared in any way with the masked value of Rpu stored previously in storage 20. Further, even if such comparison is performed, the Lewis system by design will accept, by mistake, any Rpu value chosen by an attacker where the Rpu value shares the same hash code as the authentic Rpu value.

D. In the case of masking with encryption, when a key replacement message is received by a user node a decryption key is supplied within the message and a catastrophic mistake is made by the system. The Lewis system does not provide any mechanism for verification that the decryption key is the authentic decryption key that was used previously to encrypt the authentic Rpu value (i.e. E_X(Rpu) as stored). When, as taught by Lewis, “encryption is the exclusive OR'ing of the message and the key” the security implications of this catastrophic mistake are readily apparent. With no way to distinguish an authentic decryption key from one chosen by an attacker, exclusive OR'ing the stored E_X(Rpu) value with the chosen decryption key will produce whatever Rpu value the attacker desires for this replacement key.

To illustrate, suppose an authentic replacement public key has a value of 31. In binary this is 11111. Now suppose that the Lewis system used an encryption key of 21 (binary 10101) to encrypt the value of the public key using exclusive OR'ing as taught in Lewis. The result is decimal 10 (binary 1010) because the rule for exclusive OR binary operations is “either one, but not both.” For each pair of bits the result of an exclusive OR operation is either a 1, if either of the bits is a 1, or the result is a zero, if both of the bits are the same. For encryption and decryption the exclusive OR operation is handy because the same key that is used to encrypt a plaintext value according to the exclusive OR bit pairing rule will result in decryption when the same key is used again to apply the same rule. That is, the result of an exclusive OR operation between a decryption key of 21 (binary 10101) and the previous result, decimal 10 (binary 1010), is once again a value of 31 (binary 11111). Now then, it is important to recognize that Lewis calls for a value such as decimal 10 to be stored as the E_X(Rpu) masked representation of the replacement public key, and then Lewis allows an attacker who is in possession of the active private key (Apr) to craft a new malicious key replacement message, digitally sign the message with Apr so it is verifiable by a user node that has the corresponding active public key Apu, and supply in the new key replacement message a decryption key other than the authentic key (which is equal to 21 in the example), which value presumably the attacker doesn't know.

Now suppose the attacker wishes to replace the active public key with the value of 13 instead of 31, all the attacker need do is provide a decryption key equal to 7 in the malicious replacement message. Because decimal 7 has a binary value of 111, exclusive OR'ing 7 with 10 (binary 1010) results in 13 (1101). Clearly, unless a Lewis system is extremely careful never to reveal to an eavesdropper or other attacker the value E_X(Rpu) all such a malicious party needs to do in order to take complete control of digital signature verification in a Lewis system is find the value of the active private key, Apr, then forge a digitally-signed key replacement message.

E. As a result it is clear that the masking taught by Lewis for handling of R1pu simply stinks.

The Lewis invention is designed to operate, for purposes of sending and receiving key replacement messages, on a communications medium that is vulnerable to eavesdropping. For this reason Lewis recommends that each user node have its own separate key pair and that communications with the user node be accomplished by further encrypting all communications sent to a user node with the public key associated with that user node, including communications required for key replacement messages as taught by Lewis, and in the return direction requiring the user node to encrypt, using the active public key (Apu), any communications that the user node might itself wish to send. Perhaps this is the reason that Lewis overlooks these serious defects in its preferred system of key replacement, because the end result of the Lewis system is that eavesdropping is defeated by encrypting all communications sent to and received from user nodes. However, defeating eavesdropping in such a manner isn't novel. The key replacement messages taught by Lewis are inherently unsafe, as they don't provide the protection against attacks by unauthorized parties who compromise the active private key the way Lewis intended.

The apparatus taught by Lewis requires that a mask of the next replacement public key be supplied in the key replacement message, in a form such as a hash code or as ciphertext. By this, Lewis expressly teaches away from the optimal method disclosed by the present invention. Among other drawbacks of the Lewis apparatus is the fact that an adversary who has obtained the active private key is capable of forging a verifiable key replacement message that supplies a chosen replacement public key that is different from the authentic replacement public key that was previously masked as taught by Lewis. In the case of a ciphertext masking, Lewis teaches that the replacement public key must be extracted from the stored ciphertext (i.e. E_X(Rpu)) of the replacement public key, and to make this extraction possible a decryption key must be supplied along with another encrypted replacement public key contained within the key replacement message. This requirement gives rise to the ability of said adversary to insert their own replacement public key and also to trick the Lewis system into using malicious Apu and Rpu values instead of the ones that were intended when the original masked representation of the next replacement public key was last stored.

The risk in Lewis is that the previously-supplied ciphertext mask will be decrypted using a decryption key of an adversary's choosing which will give the adversary complete control over the final plaintext value of the replacement public key, which makes it possible for the adversary to choose a public key and a private key pair known only to the adversary. At the very least, to safely implement the Lewis scheme involving ciphertext masks there must be an additional layer of authentic decryption key management and authenticity verification for the decryption key supplied with the key replacement message, or else the Lewis invention is self-defeating and any adversary who gains access to the active private key becomes capable of mounting a successful attack by forging key replacement messages that will result in a new Apu/Apr key pair, as well as a new R1pu/R1pr key pair, of the attacker's choosing and known only to the attacker.

Typically, in most digital signature schemes, the plaintext data that is obtained by using the public key to decrypt the ciphertext of the digital signature is a hash code of the message that was digitally signed. In a typical digital signature scheme, a “digital signature” is essentially an encrypted hash code, though there is often additional data contained within the digital signature as well. Decrypting the hash code enables the digital signature verification process to verify that the message it received is probably the same message that was digitally signed by the entity in possession of the private key used to formulate the digital signature. In the case of a forged digital signature an adversary has potentially discovered the private key, and so has gained the ability to form verifiable digital signature ciphertext by encrypting arbitrary hash codes such that the recipient will be able to decrypt to verify these encrypted hash codes, when decrypted, correspond to the hash code that is expected, exactly as the recipient would verify any legitimate digital signature. This type of forged digital signature is exactly the same as any legitimate digital signature, it is considered “forged” only by virtue of the fact that somebody other than the authorized private key holder formulated the digital signatures.

Alternatively, the adversary may have discovered a hash collision and used this discovery to forge a digital signature. A hash collision is any two or more messages that, when hashed according to a hash algorithm, result in identical hash codes. For instance, if a first message “hello world” hashes to a hash code of 31, it is possible that an adversary could discover a second message “goodbye world” that also hashes to a hash code of 31. Because the messages are, in general, longer than the length of the hash codes used in digital signature schemes it is known in the art of cryptology that hash collisions exist and that they are in fact very common. However, when we're dealing with a cryptographic system that transforms messages of arbitrary length into hash codes of fixed length we're dealing with seemingly-infinite numbers of possible combinations of bit sequences being condensed down to bit sequences that themselves have an enormous number of possible values. In this context, the existence of a few million billion hash collisions is considered statistically meaningless because nobody has the technical ability, yet, to try a seemingly-infinite number of possible messages searching for one of the few million billion possible messages that will result in a hash collision for a certain hash code, such as 31. With a hash code that is such a small number, of course, the difficulty of finding a hash collision is minimal, but hash algorithms typically use hash code values that are hundreds of bits in length.

Alternatively, the adversary may discover a classical information security vulnerability of the sort that allows the adversary to overflow a stack or a heap buffer, for example, and force the execution of arbitrary code within a microprocessor that is being used in the system to verify digital signatures. Such exploitation of classical information security vulnerabilities can result in the forced replacement of key values with keys of the attacker's choosing, or allow the attacker to tamper with potentially any other data stored anywhere within the system. Defenses against this risk are not cryptographic in nature and are outside the scope of this document, but such defenses are known in the prior art including dividing up the memory and processor components of the system into discrete modules that have internal policy enforcement and credential requirements for access controls that govern sensitive data elements such as stored cryptographic keys. Modular system design is presumed herein as an engineering best-practice.

Hundreds of bits makes for an enormous number of possibilities, but when messages are thousands or tens of thousands or hundreds of thousands of bits in length it is obvious that the number of hash collisions that must exist in reality are very large. The larger the message in relationship to the length of the hash code, the larger the number of hash collisions there must be.

39 Importantly, every single digital signature that is created using a hash code-based digital signature scheme is potentially reusable as a verifiable digital signature for every single one of the messages that share the same hash code as the digitally-signed message. In other words, the formulation of a digital signature using a hash code encrypted by a private key is the same thing as digitally-signing a few million billion messages using that private key, if that's the number of hash collisions that exist for a given message length and hash code length under a particular hash code algorithm. For this reason most digital signature schemes employ additional verification mechanisms such as using more than one hashing algorithm (reducing the likelihood that anyone will ever be able to discover a message that has two hash collisions in common with an authentic digitally-signed message) or use timestamps and other information security defenses to prevent the “replay” of an authentic digital signature by an adversary.

When considering these issues in light of the Lewis invention, however, the existence of millions of billions of hash collisions given a typical digital signature scheme becomes a critical vulnerability for the Lewis key replacement message integrity. The reason is that the Lewis system relies on hash codes or digital signatures that use hash codes as the basis of verifying the integrity of a replacement key supplied in a key update message as taught by Lewis. Even in the case where an engineer who implements the Lewis invention is careful to ensure that the hash code supplied previously matches the hash code of the replacement key (when that replacement key is actually received by way of a Lewis key replacement message) there is still no way for such engineer to know whether the hash code matches because the replacement key is the authentic replacement key, or whether the hash code matches because of a hash collision that was discovered by an adversary. The practical implication by design in Lewis are that an adversary can potentially choose any one of a million billion replacement keys that represent hash collisions for the authentic replacement key and, with only the authentic active private key in the adversary's possession, trick the Lewis system into accepting and verifying the digital signature of one of those keys, known to the adversary, instead of correctly restricting the key update to the authentic replacement key that is known only to the rightful owner of the active and replacement public/private cryptographic key pairs.

The present invention avoids this vulnerability by ensuring that the entire replacement public key is present on the system in advance of the time that the system will be required to process and verify a key replacement message rather than storing or transmitting only the mask of such replacement key as taught by Lewis. This ensures that, worst-case, the only thing an adversary can do, without knowledge of the replacement private key, is attempt to cause a denial of service (DoS) condition by forging a key replacement message that might succeed in causing the system to receive and install a new key, the value of which neither the adversary nor the rightful owner of the system know. Techniques for preventing such DoS conditions are well-known in the prior art, but one possibility is to require that a key replacement message, when decrypted, contains a structured message the structure of which can be verified before the replacement key is put into use in the system. For example, a particular sequence of letters making up a command word might be part of the plaintext data structure of the key replacement message. The difficulty for an adversary of finding a hash collision for a structured message plus a random cryptographic key, where the structure of the message and its required command string remain unchanged, yet the random cryptographic key is altered so that is has a different value, is considered by cryptologists to be nearly impossible in practice. However, Lewis makes no mention of any of these common engineering challenges for the practical implementation of digital signatures and it is clear that the invention taught by Lewis cannot be safely implemented without a substantial amount of additional work and countermeasures to defend against peculiar hidden risks inherent to the Lewis system.

In the case where the previously-stored mask is a hash code rather than an encrypted copy of the next replacement public key, the engineer who implements the Lewis apparatus must go beyond the Lewis teachings and explicitly confirm that the previously-stored mask indeed matches a newly-computed mask using the same hash algorithm taking the plaintext of the full replacement public key as input to the hash algorithm, yet even when doing so such engineer will not necessarily succeed in preventing all possible hash collisions or other vulnerabilities inherent to such a hash-based mask verification. Clearly the Lewis invention has introduced new layers of complexity that require an elegant, novel solution instead for cryptographic key replacement.

Other systems related closely to the subject of the present invention do not address the problem of needing to avoid a dependency on a compromised or lost private key, nor do they come any closer to realizing a substantially better method for digitally-signed key replacement. The present invention's use of a second public key for verification of the digital signatures associated with key replacement events provides superior resistance to cryptanalysis, reducing risk that a key replacement digital signature can ever be forged by a sophisticated adversary.

Systems such as Lewis introduce new layers of complexity as well as new vulnerabilities that the present invention reveals are technically avoidable.

### BRIEF SUMMARY OF THE INVENTION

Certain embodiments of the present invention provide a method for replacing a cryptographic key including receiving a key replacement message for replacing the cryptographic key, decrypting at least part of the key replacement message using at least part of the cryptographic key, reading from the key replacement message at least part of at least a first replacement cryptographic key or at least a first replacement cryptographic key precursor value that is used to derive a first replacement cryptographic key, and replacing the cryptographic key with at least part of the first replacement cryptographic key. The key replacement message includes encrypted data. The encrypted data having been encrypted using at least part of at least a third cryptographic key. Decrypting the encrypted data using at least part of the cryptographic key. The decrypting being associated with verifying a digital signature. Successful replacement of the cryptographic key being dependent upon successfully decrypting the encrypted data and successfully verifying a digital signature. Upon successful replacement of the cryptographic key, replacing a second cryptographic key with the cryptographic key. In certain embodiments the cryptographic key may be a root key corresponding to a root certificate that is part of a public key cryptosystem. In certain embodiments the cryptographic key and the second cryptographic key are considered to be public keys, and a first cryptographic key and the third cryptographic key are considered to be private keys, in an asymmetric cryptosystem.

### BRIEF DESCRIPTION OF SEVERAL VIEWS OF THE DRAWINGS

FIG. 1 illustrates a system for cryptographic key replacement according to an embodiment of the present invention.

FIG. 2 illustrates a flow diagram for a method for cryptographic key replacement according to an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

As discussed above, a digital signature is a cryptographic transformation involving at least one key, or employing at least one secret algorithm as a substitute for a key, in order to transform a message such that the result of the transformation can be compared against an expected result during a signature verification process to determine whether it is probable that the message was, at some time in the past, under the control of an entity that was capable of transforming the message so that the expected result of said comparison would be obtained by an entity that attempts to verify the digital signature in the future. The first transformation of the message typically results in a hash code of the message, which hash code is encrypted using a first key. The comparison is typically the decryption of the hash code using a second key that corresponds to the first key followed by comparing the decrypted hash code to the hash code that is obtained by once again hashing the message using the same one-way function hash algorithm. The expected result of such comparison is that the decrypted hash code should match the hash code computed again by hashing the message. Unless a hash collision occurs, these cryptographic transformations and the resulting comparison tend to confirm that the message that was signed is the same as the message that was received along with the digital signature data.

As discussed above, a key may be either a numeric value or an algorithm. Keys may be public, private, or secret. A public key and a private key are related to each other, mathematically, or by way of their algorithm design. A secret key stands alone as a numeric value or algorithm that is required for any cryptographic transformation to occur. A secret key is not related to another key. Cryptographic transformations made with a secret key are said to be reversible with that same key, whereas transformations made with either a public key or a private key are only reversible using the corresponding related key. Public key and private key cryptosystems are also known as asymmetric, while cryptosystems that employ secret keys are known as symmetric cryptosystems owing to symmetry between encryption and decryption keys.

Certain embodiments of the present invention solve security problems that result from the need to replace a trusted key within a cryptographic system. Certain embodiments provide for the establishment of a mechanism to enable a key to be replaced by sending a key replacement message including a digital signature and a replacement key. The digital signature contained within the key replacement message is created using a key that is not related to the key being replaced, or else an adversary who discovers the private key corresponding to the public key that is being replaced will be capable of forging a verifiable key replacement message that supplies a malicious replacement key the system will use in any subsequent digital signature verification.

Certain embodiments of the present invention provide a cryptographic command and control system that delivers instructions in the form of messages that include associated, attached, or embedded digital signatures. The system relies on its ability to verify the digital signature associated with a given message to confirm that the message is trusted before relying on the contents of the message. When a digital signature is created, a digital signing process is used. When a digital signature is verified by the recipient of a signed message, a digital signature verification process is used. The digital signature creation and verification may utilize cryptographic keys. When a key replacement message is received, the system will replace the cryptographic key used for verifying digital signatures with a new key. In certain embodiments, a cryptographic key remains dormant, normally unused but available to be used, at the location of the digital signature verification process until such time as a message is received that instructs the recipient to replace the digital signature verification key. Such a message, termed a key replacement message, is digitally signed using the private key that corresponds to the dormant public key rather than being digitally signed using the private key that is normally used to create digital signatures for received messages. As a result, only the dormant public key can be used to verify the digital signature of a key replacement message.

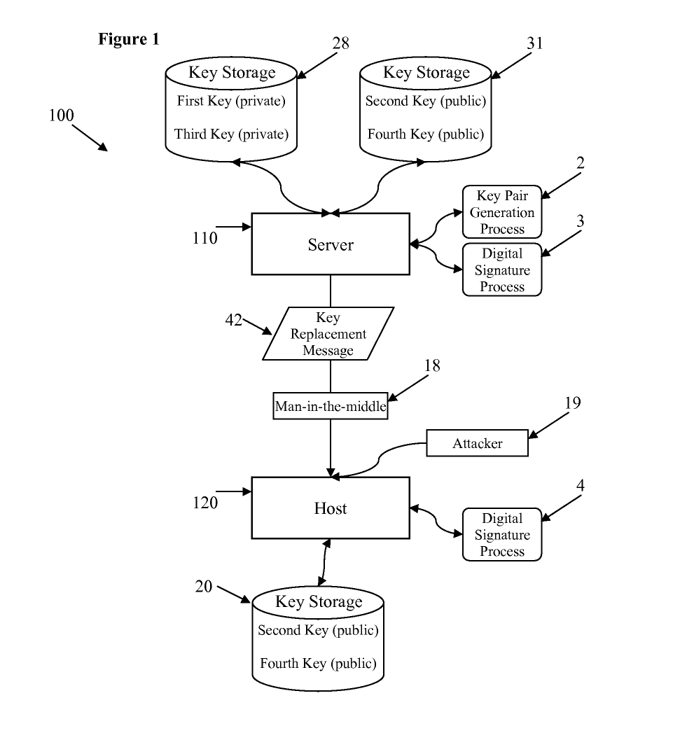

FIG. 1 illustrates a system 100 for cryptographic key replacement according to an embodiment of the present invention. The system 100 includes a server 110 and a host 120. The server 110 is in communication with the host 120 at least for unidirectional sending of messages. The host 120 has access to a key storage 20 and a digital signature process 4. The server 110 has access to a key storage 28, a digital signature process 3, and, optionally, a key pair generation process 2 and key storage 31. Man-in-the-middle 18 may intercept key replacement message 42. Attacker 19 may attempt to impersonate the server 110 and send messages including a key replacement message 42 to the host 120.

In operation, the server 110 communicates a key replacement message 42 to the host 120. The key replacement message 42 includes at least a digital signature and a replacement key. The key replacement message 42 is utilized to replace a fourth key being held by the host 120. In certain embodiments, the fourth key is a spare key that remains dormant until activated.

As mentioned, the host 120 includes both a second key and a fourth key. The host 120 may routinely utilize the second key to decrypt data as part of digital signature verification. For example, the host 120 may use the second key to decrypt encrypted hash codes of messages that are sent to it by another system, such as the server 110. The second key may be a root key.

Digital signatures may be created using the first key that is related, mathematically, to the second key. The digital signature may be created by the server 110 as part of sending digitally-signed command messages to host 120 for execution thereupon, for example. The host 120 is adapted to use the second key to verify digital signatures created using the related first key.

When the host 120 receives a digitally-signed command message, the host decrypts an encrypted hash code contained within the digital signature of the command message and the host 120 then transforms the command message using a one-way hash function and compares the result with the decrypted hash code, the expected result of which is an exact match between codes which indicates the message received is probably the same as the message that was signed.

The digital signature associated with a key replacement message 42 is verified based at least in part on a key different from the second key. For example, the host 120 may include a fourth key. The fourth key may be used to verify the digital signature associated with the key replacement message 42, for example. A third key related to the fourth key is used by server 110 to create the digital signature associated with the key replacement message 42, for example. The host 120 never receives the third key nor the first key which are used only by server 110 for the purpose of encrypting data that will be decrypted by host 120 using the corresponding key, the encrypted data being typically an encrypted hash code that was computed by server 110 by transforming a message using a one-way hash function, for example. It is never necessary for server 110 and host 120 to be in communication over a secure communications channel in order for host 120 to possess the second and fourth keys because host 120 can be manufactured with these keys installed, or host 120 may be configured by a user who enters these keys into key storage 20. The server 110 or another entity may also deliver a second and a fourth cryptographic key in an initial configuration step (not shown) by including these keys in software or publishing the keys on a public key server that is not necessarily secure but that users nevertheless trust. For example, a user may download these two keys, or software that contains them, from the Internet.

In certain embodiments, the fourth key is never used to decrypt data prior to its use in verifying the digital signature associated with a key replacement message 42. For example, the fourth key may be stored on the host 120 but it remains dormant, not being used to decrypt data prior to its initial use when verifying the digital signature associated with the key replacement message 42. This prevents an adversary from attempting to discover the third key which corresponds to the fourth key through cryptanalysis of ciphertext that is produced using the third key. Dedicating the fourth key to the initial singular purpose of verifying the digital signature using the third cryptographic key when a key replacement message 42 is received and processed may be helpful in ensuring that no unauthorized third party will have any way to discover the third key, the key that is required in order to send a verifiable key replacement message 42 and digital signature, except for such third party to discover the third key by way of a cryptanalytical attack that uses the fourth key to iteratively try to decrypt chosen ciphertext created using every possible third cryptographic key until the correct third cryptographic key is determined. Such cryptanalysis is referred to as a brute force attack and is considered impractical for long key lengths, however it may be effective given enough time, computing speed, or in other cryptanalytical circumstances. A man-in-the-middle 18 or an attacker 19 may have acquired a copy of the fourth key previously so either one could attempt to deduce the third key using a brute force method of cryptanalysis.

Provided, then, that no other cryptanalytical method is discovered that enables a holder of the fourth key to deduce the value of the third cryptographic key based on some property of the fourth key, the cryptographic system will not be vulnerable to attacks except brute force chosen ciphertext cryptanalysis for the purpose of key discovery that might compromise the third key.

If the digital signature associated with a key replacement message 42 is successfully verified, the fourth key on host 120 is replaced in key storage 20 with the value of the replacement key. If the key replacement message's digital signature is not successfully verified the fourth key is not replaced. In certain embodiments, the second key is replaced with the previous value of the fourth key. In certain embodiments there is a key storage 31 accessible to the server 110 into which the value of the new fourth key is placed, likewise replacing the previous value of the second key with the previous value of the fourth key within key storage 31. In some embodiments a key replacement protocol enables the host 120 to inform the server 110 that the key replacement message 42 was received and processed successfully and that the key replacement requested by a key replacement message 42 has occurred as expected within the key storage 20.

In certain embodiments, the key replacement message 42 includes a second replacement key. When the digital signature associated with the key replacement message 42 is successfully verified, the second key may be replaced by the first replacement key and the fourth key may be replaced by the second replacement key. The second replacement key may then remain unused for decrypting any ciphertext associated with any digital signature until another key replacement message 42 is received by the host 120 again in the future.

The components, elements, and/or functionality of the system 100 may be implemented alone or in combination in various forms in hardware, firmware, and/or as a set of instructions in software, for example. Certain embodiments may be provided as a set of instructions residing on a computer-readable medium, such as a memory or hard disk, for execution on a general purpose computer or other processing device.

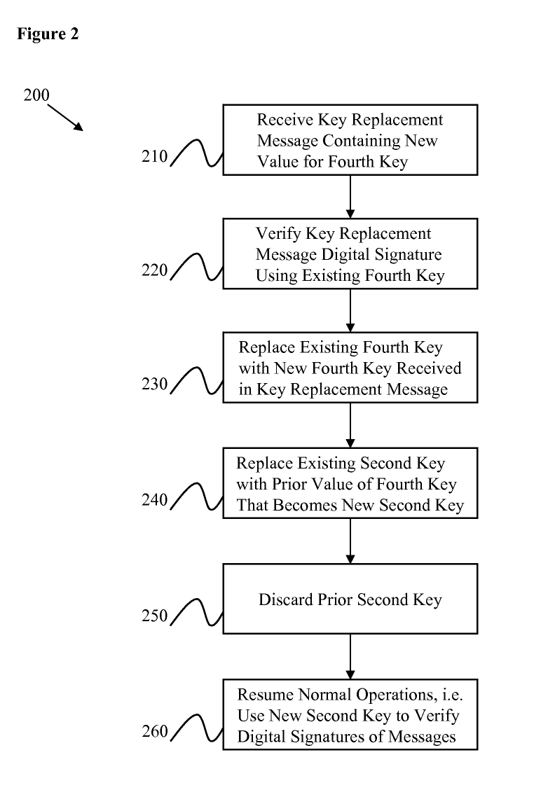

FIG. 2 illustrates a flow diagram for a method 200 for cryptographic key replacement according to an embodiment of the present invention. The method 200 includes the following steps, which will be described below in more detail. At step 210, a key replacement message is received that contains a new value for a fourth key. At step 220, the key replacement message digital signature is verified using an existing value for a fourth key. At step 230, the existing value for a fourth key is replaced with the new key that was received in the key replacement message. At step 240, the value of a second key is replaced with the previous value of the fourth key. At step 250, the previous value of the second key is discarded. At step 260, normal operations of the system resume using the new second key to verify digital signatures, for example digital signatures of messages. The method 200 is described with reference to elements of systems described above, such as system 100, but it should be understood that other implementations are possible.

At step 210, a key replacement message is received. The key replacement message may be received at a host similar to host 120, described above, for example. The key replacement message may be received from a server similar to server 110, described above, for example. The key replacement message may be similar to the key replacement message 42 described above, for example, and may contain at least a digital signature and at least a first replacement key.

The key that is replaced by the key replacement message is the fourth key, which was held by the host 120, for example, in anticipation of receiving a key replacement message at some point which message would include a digital signature that could only be verified using the fourth key. Advantageously, certain embodiments of the system may also replace the second key with the previous value of the fourth key when a valid key replacement message is received that provides a replacement fourth key for host 120 to use in the future when a new key replacement message is received, for example. Whereas the fourth key is held in reserve and is not used until a key replacement message is received, the second key is used during normal system operation to verify digital signatures, for example when the system receives messages that are not key replacement messages. Once a fourth key has been used to verify a digital signature of a key replacement message, that fourth key is necessarily replaced with the new fourth key supplied within the key replacement message and it may be advantageous for the system to begin using the previous value of the fourth key as the new value of the second key.

The digital signature contained within the key replacement message is generated using a third key that is known only to the sender of the key replacement message. The third key is different than the first key that may have been used previously to create digital signatures that the host 120 verified using the second key during normal operations of the system, for example. The digital signature may be generated by the server 110 as part of composing the key replacement message, for example. Any digital signature scheme may be used by the system for generating and verifying digital signatures within the system.

At step 220, a digital signature supplied in the key replacement message is verified. The key replacement message may be the key replacement message received at step 210, described above, for example. The digital signature contained within the key replacement message may be verified by a host similar to the host 120, described above, for example.

A digital signature contained within the replacement message may be verified based at least in part on a key different from the second key. For example, the host 120 may include a fourth key. The fourth key may be used to verify the key replacement message, for example.

In certain embodiments, the fourth key is not used prior to its use in verifying a digital signature contained within a key replacement message. For example, the fourth key may be stored on the host 120 in key storage 20, but may not be used to decrypt data prior to being used to verify a digital signature contained within a key replacement message. In certain embodiments the fourth key may be used to encrypt data in advance of the fourth key being used to decrypt data during verification of a digital signature contained within a key replacement message. For example, the fourth key may be used as an encryption key for sending private encrypted messages to the server 110 which may decrypt the encrypted messages using its third key.

At step 230, a key is replaced. The key may be replaced after a digital signature contained within the key replacement message is successfully verified at step 220, described above, for example, and no key may be replaced if a signature cannot be verified. The key that is replaced may be the fourth key contained in key storage 20 that is accessible to the host 120, for example.

For example, if a digital signature contained within the key replacement message is successfully verified, the fourth key in key storage 20 accessible to the host 120 is replaced with the replacement key. If a digital signature contained within the key replacement message is not successfully verified, the fourth key in key storage 20 may not be replaced. This may occur when, for example, the key replacement message has been forged, tampered with, or corrupted. This will occur when, for example, man-in-the-middle 18 or attacker 19 send a malicious key replacement message the to host 120 but are unable to create a valid digital signature that can be verified by the host 120 using the existing fourth key. When a man-in-the-middle 18 or attacker 19 do not possess a copy of the third key contained in key storage 31, for example, it is expected these adversaries will be unable to create a valid digital signature for a key replacement message.

At step 240, the existing second key contained within key storage 20, for example, is replaced with the previous value of the fourth key before the fourth key was replaced in step 230.

In certain embodiments, the key replacement message includes a second replacement key. When a digital signature contained within the key replacement message is successfully verified, the fourth key may be replaced by the second replacement key. The second replacement key may then remain unused for decrypting data until another key replacement message is received.

At step 250, the second key that was previously stored in key storage 20, for example, may be discarded after it is replaced by a new value for the second key as in step 240.

At step 260, the system resumes normal operation whereby, for example, the new second key is used for verification of digital signatures associated with messages received by host 120.

One or more of the steps of the method 200 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. Certain embodiments may be provided using Field Programmable Logic Arrays (FPLA), Application Specific Integrated Circuits (ASIC), Read Only Memory (ROM), smart cards, or other hardware device such as an integrated circuit or specialized microprocessor.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

Thus, certain embodiments of the present invention provide systems and methods for updating a cryptographic key. Certain embodiments provide for root certificate update. Certain embodiments of the present invention provide a technical effect of updating a cryptographic key. Certain embodiments provide a technical effect of root certificate update.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for replacing a cryptographic key, the method including:
receiving a key replacement message for replacing a fourth cryptographic key, wherein the key replacement message includes encrypted data, the encrypted data having been encrypted using at least part of at least a third cryptographic key;
decrypting at least part of the key replacement message using at least part of the fourth cryptographic key, the decrypting being associated with verifying a digital signature;
reading from the key replacement message at least part of at least a first replacement cryptographic key or at least a first replacement cryptographic key precursor value that is used to derive a first replacement cryptographic key; and
replacing the cryptographic key with at least part of the first replacement cryptographic key.

2. The method of claim 1, wherein the fourth cryptographic key has not been previously used to decrypt data which was associated with verifying a digital signature.

3. The method of claim 1, wherein the key replacement message includes a second replacement cryptographic key.

4. The method of claim 1, wherein at least part of a second cryptographic key is replaced with at least part of the cryptographic key, where the second cryptographic key may be a root key corresponding to a root certificate in a public key cryptosystem.

5. The method of claim 1, wherein the fourth cryptographic key and the cryptographic key are the same key.

6. The method of claim 2, wherein the fourth cryptographic key and the cryptographic key are the same key.

7. The method of claim 3, further including replacing the fourth cryptographic key with the second replacement cryptographic key.

8. The method of claim 1, wherein the first replacement cryptographic key is never used to decrypt encrypted data until a second key replacement message is received as a new first key replacement message.

9. The method of claim 2, wherein the first replacement cryptographic key is never used to decrypt encrypted data until a second key replacement message is received as a new first key replacement message.

10. The method of claim 3, wherein the first replacement cryptographic key is never used to decrypt encrypted data until a second key replacement message is received as a new first key replacement message.

11. The method of claim 4, wherein the first replacement cryptographic key is never used to decrypt encrypted data until a second key replacement message is received as a new first key replacement message.

12. The method of claim 5, wherein the first replacement cryptographic key is treated as the cryptographic key for purposes of applying the method again with the new first key replacement message.

13. The method of claim 6, wherein the first replacement cryptographic key is treated as the cryptographic key for purposes of applying the method again with the new first key replacement message.

14. The method of claim 7, wherein the first replacement cryptographic key is treated as the cryptographic key for purposes of applying the method again with the new first key replacement message.

15. The method of claim 8, wherein the first replacement cryptographic key is treated as the cryptographic key for purposes of applying the method again with the new first key replacement message.

16. A method of replacing a cryptographic key by communicating to a receiving party a new cryptographic key, together with a means of verification to prove to the party that the new cryptographic key is an authentic replacement key, where such means of verification employs a cryptographic transformation that involves computation using a fourth cryptographic key which was previously communicated to the party, and where the fourth cryptographic key was never previously used as a cryptographic key in any other cryptographic transformation by the party, and replacing said cryptographic key only after successful verification of authenticity for said new cryptographic key by said means of verification employing the fourth cryptographic key.

17. A system for replacing a cryptographic key, the system including:
a host including a cryptographic key, wherein the host is adapted to receive a key replacement message including a first replacement cryptographic key, wherein the key replacement message has been encrypted at least in part using a third cryptographic key, wherein the host is further adapted to decrypt at least in part the key replacement message using the cryptographic key to read the first replacement cryptographic key, wherein the host is adapted to replace the cryptographic key with the first replacement cryptographic key.

18. The system of claim 17, wherein the host includes a second cryptographic key that is replaced with the cryptographic key when the cryptographic key is replaced with the first replacement cryptographic key.

19. The system of claim 17, wherein the first replacement cryptographic key is never used to decrypt encrypted data until a second key replacement message is received as a new first key replacement message.

20. The system of claim 18, wherein the first replacement cryptographic key is never used to decrypt encrypted data until a second key replacement message is received as a new first key replacement message.
